(19) United States
(12) Patent Application Publication
(10) Pub. No.: US 2011/0050849 A1
(43) Pub. Date: Mar. 3, 2011

(54) METHOD AND APPARATUS FOR RECEIVING SYNCHRONIZATION SIGNAL AND METHOD AND APPARATUS FOR CONTROLLING OF 3D SHUTTER GLASSES USING THE SAME

(75) Inventors: Ho-seop LEE, Seongnam-si (KR); Dae-sik KIM, Hwaseong-si (KR); Young-ji KO, Seoul (KR); Soo-bae MOON, Suwon-si (KR)

(73) Assignee: SAMSUNG ELECTRONICS CO., LTD., Suwon-si (KR)

(21) Appl. No.: 12/794,836

(22) Filed: Jun. 7, 2010

(30) Foreign Application Priority Data
Aug. 27, 2009 (KR) 10-2009-0080033

(51) Int. Cl. H04N 13/04; H04N 5/04; H04N 13/00

(52) U.S. Cl. 348/43; 348/500; 348/53; 348/E13.075; 348/E05.009

(57) ABSTRACT

An apparatus for receiving a sync signal and an apparatus for controlling a three-dimensional (3D) shutter glass using the same. The apparatus for receiving the synchronization signal includes: a synchronization signal receiver which receives a synchronization signal from a source unit; and a controller which analyzes a period of the received synchronization signal and generates a mode signal according to the analyzed period of the received synchronization to control the synchronization signal receiver, wherein the synchronization signal receiver can be selectively operable to receive the synchronization signal according to the mode signal

### CROSS-REFERENCE TO RELATED PATENT APPLICATION

This application claims the benefit of Korean Patent Application No. 10-2009-0080033, filed on Aug. 27, 2009, in the Korean Intellectual Property Office, the disclosure of which is incorporated herein in its entirety by reference.

### BACKGROUND

1. Field

The exemplary embodiments relate to a method and apparatus for receiving a synchronization signal and a method and apparatus for driving three-dimensional (3D) glasses using the same, and more particularly, to a method of receiving a sync signal that may reduce current consumption of an apparatus for receiving a sync signal and current consumption of 3D shutter glasses and a method and apparatus for controlling shutters of 3D glasses.

2. Description of the Related Art

Three-dimensional (3D) glasses use binocular disparity to allow a viewer to perceive images as 3D images. An image viewed by the left eye and the image viewed by the right eye may be perceived different from each other, and the perceived difference between the image viewed by the left eye and the image viewed by the right eye is called binocular disparity. The brain is trained to see binocular disparity as depth information.

Using this binocular disparity, a 3D display device outputs a left eye image and a right eye image, and controls a left shutter and a right shutter of 3D glasses worn by a user to be turned on or off according to when the left eye image and the right eye image are output from the 3D display device, thereby enabling the left eye to see the left eye image and the right eye to see the right eye image and thus allows the user to perceive an image as a 3D image.

FIG. 1 illustrates a conventional liquid crystal display (LCD) shutter driving signal.

An infrared (IR) transmitter of a display device periodically transmits a sync signal Vsync at 60 Hz. That is, in FIG. 1, the display device displays left and right eye images at 60 Hz, and sends a sync signal to operate left and right shutters of 3D glasses according to the period. Accordingly, a receiver of the 3D glasses receives the sync signal, and drives the left and right shutters synchronously with the left and right images displayed on the display device.

### SUMMARY

The exemplary embodiments provide an apparatus for receiving a sync signal and a method of using shutter glasses for a long time with the same battery by reducing current consumption of an apparatus for receiving a sync signal and current consumption of the shutter glasses.

According to an aspect, there is provided a synchronization signal receiver device including: a synchronization signal receiver which receives a synchronization signal from a source unit; and a controller which analyzes a period of the received synchronization signal and generates a mode signal according to the analyzed period of the received synchronization to control the synchronization signal receiver, wherein the synchronization signal receiver can be selectively operable to receive the synchronization signal according to the mode signal.

The synchronization signal receiver which receives the mode signal from controller may receive the synchronization signal during a predetermined period.

The controller may generate a first mode signal which makes the synchronization signal receiver get status on to receive the synchronization signal and a second mode signal which makes the synchronization signal receiver get status of wherein the first mode signal is transferred before the synchronization receiver receives the synchronization signal and the second mode signal is transferred after the synchronization receiver receives the synchronization signal.

The synchronization signal receiver may operate at least one receiver operation and then off status each period of the synchronization signal

The controller may generate a mode signal each period of the synchronization signal and transfers it to synchronization signal receiver.

The controller may include an external signal receiver, wherein if the external signal receiver receives a predetermined signal, the controller initializes the mode signal and then regenerates a mode signal.

According to another aspect, there is provided a method of receiving a synchronization signal, the method including: receiving a synchronization signal from a source unit; analyzing a period of the received synchronization signal; generating a mode signal according to the analyzed period of the received synchronization to control a device for receiving the synchronization signal, and selectively controlling a synchronization signal receivable state of the device for receiving the synchronization signal according to the mode signal.

The selectively controlling of a synchronization signal receivable state of the device may include setting the device in a synchronization signal receivable state during a predetermined period.

According to another aspect, there is provided a 3D shutter glass including: a synchronization signal receiver which receives a synchronization signal from a source unit; and a controller which generates a shutter control signal to control a 3D shutter glass and a mode signal to control the synchronization signal receiver based on the received synchronization signal; and a shutter operation unit operates selectively a left shutter or a right shutter according to the generated shutter control signal, wherein the synchronization signal receiver can be selectively operable to receive the synchronization signal according to the mode signal

The synchronization signal receiver which receives the mode signal from the controller can receive the synchronization signal during a predetermined period.

According to another aspect, there is provided a method of controlling 3D shutter glass, the method including: receiving a synchronization signal from a source unit; generating a shutter control signal for controlling a 3D shutter glass and a mode signal for controlling a device for receiving a synchronization signal based on the received synchronization signal; selectively operating a left shutter or a right shutter according to the generated shutter control signal, and selectively controlling a synchronization signal receivable state of the device for receiving the synchronization signal according to the mode signal.

According to another aspect, there is provided a computer-readable recording medium having embodied thereon a program for executing a method of controlling a 3D shutter glass, wherein the method includes: receiving a synchronization signal from a source unit; generating a shutter control signal for controlling a 3D shutter glass and a mode signal for controlling a device for receiving a synchronization signal based on the received synchronization signal; selectively operating a left shutter or a right shutter according to the generated shutter control signal, and selectively controlling a synchronization signal receivable state of the device for receiving the synchronization signal according to the mode signal.

According to another aspect, there is a method of controlling 3D glasses including a left shutter and a right shutter, the method including: receiving a sync signal from a source unit; generating a shutter control signal for controlling a left shutter and a right shutter of the 3D glasses and a mode signal for controlling the receiving of the sync signal based on the received sync signal; selectively operating the left shutter or the right shutter according to the generated shutter control signal, and selectively controlling the receiving the sync signal by setting a receiving state to be ON when receiving a pulse of the sync signal and the receiving state to be OFF when not receiving the pulse of the sync signal.

### BRIEF DESCRIPTION OF THE DRAWINGS

The above and other features the exemplary embodiments will become more apparent by describing in detail with reference to the attached drawings in which:

FIG. 1 illustrates a conventional liquid crystal display (LCD) shutter driving signal;

FIG. 2 is a block diagram of an apparatus for receiving a sync signal, according to an exemplary embodiment;

FIG. 3 illustrates a sync signal according to an exemplary embodiment;

FIG. 4 is a flowchart illustrating a method of receiving a sync signal, according to an exemplary embodiment;

FIG. 5 is a block diagram of an apparatus for controlling left and right shutters of three-dimensional (3D) glasses, according to an exemplary embodiment;

FIG. 6 is a flowchart illustrating a method of controlling left and right shutters of 3D glasses, according to an exemplary embodiment;

FIG. 7 is a block diagram of an apparatus for receiving a sync signal, according to another exemplary embodiment;

FIG. 8 is a flowchart illustrating a method of receiving a sync signal, according to another exemplary embodiment;

FIG. 9 is a block diagram of an apparatus for controlling left and right shutters of 3D glasses, according to another exemplary embodiment; and

FIG. 10 is a flowchart illustrating a method of controlling left and right shutters of 3D glasses, according to another exemplary embodiment.

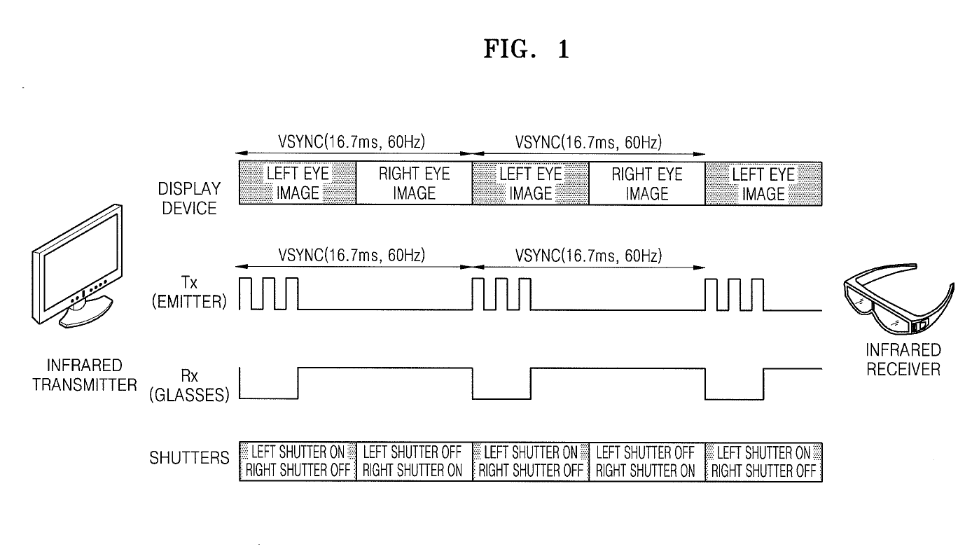

### DETAILED DESCRIPTION

The exemplary embodiments will now be described more fully with reference to the accompanying drawings.

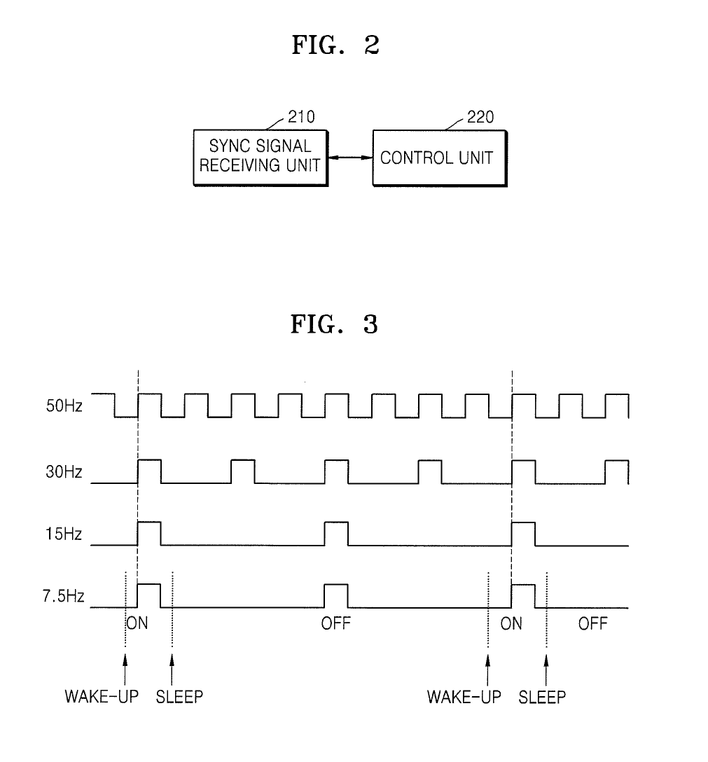

FIG. 2 is a block diagram of an apparatus for receiving a sync signal, according to an exemplary embodiment. The apparatus for receiving the sync signal includes a sync signal receiving unit 210, and a control unit 220 that may be, for example, a micro control unit (MCU).

The sync signal receiving unit 210 may detect a sync signal received from for example, a transmitter (not shown) of a three-dimensional (3D) display device, and transmits the sync signal to the control unit 220. The sync signal received by the sync signal receiving unit 210 may be a specific signal transmitted using wireless communication such as infrared (IR), Bluetooth, wireless local area network (WLAN), or Zigbee.

The control unit 220 analyzes a period of the sync signal, and transmits a sleep mode signal enabling the sync signal receiving unit 210 to be set in a sleep state and a wake-up mode signal enabling the sync signal receiving unit 210 to be set in a wake-up state, to the sync signal receiving unit 210 according to the period of the sync signal.

For example, the control unit 220 analyzes the period of the sync signal, and transmits the wake-up mode signal and the sleep mode signal to the sync signal receiving unit 210 so that the sync signal receiving unit 210 is set in a sync signal receivable state for a duration in which the sync signal is received, and the sync signal receiving unit 210 is set in an off state for a duration in which the sync signal is not received.

Accordingly, as shown in FIG. 3, the sync signal receiving unit 210 receives the wake-up mode signal before receiving the sync signal so that the sync signal receiving unit 210 is set in a reception waiting state, that is, the on state, and receives the sleep mode signal after receiving the sync signal so that the sync signal receiving unit 210 is set in the off state until a following sync signal is received. That is, since the control unit 220 controls the sync signal receiving unit 210 to be set in the reception waiting state only for a predetermined period of time, and then to be set in the off state for a remaining period of time, current consumption of the apparatus for receiving the sync signal may be minimized.

In other words, the control unit 220 analyzes the period of the sync signal, and generates a mode signal according to a minimum period, and the sync signal receiving unit 210, according to the mode signal, performs a reception operation only for a predetermined period of time necessary to receive the sync signal.

Alternatively, instead of selectively sending a wake-up mode signal at predetermined intervals for each sync signal, whenever the sync signal is received, the wake-up mode signal may be sent after a predetermined period, for example, for every 5^{th} sync signals. That is, right before each 5^{th} sync signal is received, a wake-up mode signal is sent to the sync signal receiving unit 210, so that the sync signal receiving unit 210 may be set in the off state for a longer period of time, thereby further reducing current consumption.

In FIG. 2, since the sync signal receiving unit 210 and the control unit 220 of the apparatus for receiving the sync signal both transmit to and receive information from each other, the sync signal receiving unit 210 may receive a mode signal from the control unit 220 for the sync signal receiving unit 210 to be set in the sync signal receivable state for a predetermined period of time, that is, a period of time necessary to receive the sync signal, and may receive different mode signal for the sync signal receiving unit 210 to be set in the of state for a remaining period of time, thereby minimising current consumption of the apparatus for receiving the sync signal and reducing battery usage of the apparatus for receiving the sync signal.

That is, while a conventional apparatus for receiving a sync signal is configured such that information is transmitted only from a sync signal receiving unit to a control unit, since the apparatus for receiving the sync signal of FIG. 2 is configured such that the control unit 220 may transmit a mode signal for enabling the reception waiting state of the sync signal receiving unit 210 to the sync signal receiving unit 210, the sync signal receiving unit 210 may perform its intended function and current consumption of the sync signal receiving unit 210 may also be reduced.

The apparatus for receiving the sync signal of FIG. 2 may be applied, instead of to 3D glasses, to other various devices that may receive a sync signal.

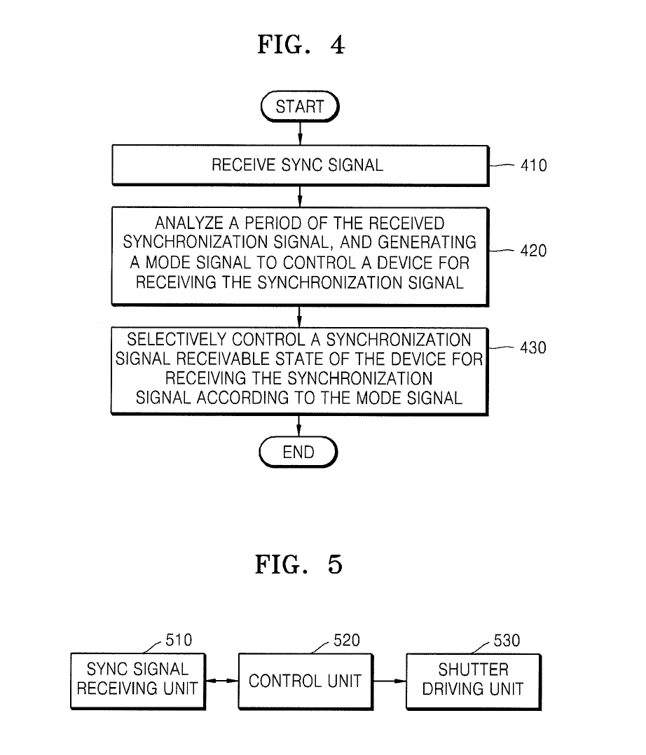

FIG. 4 is a flowchart illustrating a method of receiving a sync signal using the apparatus for receiving the sync signal of FIG. 2, according to an exemplary embodiment.

In operation 410, a sync signal is received from, for example, a sync signal transmitter of a 3D display device.

In operation 420, a period of the sync signal is analyzed, and a mode signal for selectively setting the apparatus for receiving the sync signal in the sync signal receivable state according to the period of the sync signal is generated.

In operation 430, the apparatus for receiving the sync signal is selectively set in the sync signal receivable state according to the mode signal. For example, the apparatus for receiving the sync signal is set in the sync signal reception waiting state or is set in the off state according to the mode signal.

FIG. 5 is a block diagram of an apparatus for controlling left and right shutters of 3D glasses, according to an exemplary embodiment. The apparatus for controlling the left and right shutters of the 3D glasses includes a sync signal receiving unit 510, a control unit 520 that may be, for example, an MCU, and a shutter driving unit 530.

The sync signal receiving unit 510 detects a sync signal received from a transmitter (not shown) of a 3D display device, and transmits the sync signal to the control unit 520. The sync signal received by the sync signal receiving unit 510 may be a specific signal transmitted using wireless communication such as IR, Bluetooth, WLAN, or Zigbee.

The control unit 520 generates a shutter control signal for controlling the left and right shutters of the 3D glasses according to the sync signal, and transmits the shutter control signal to the shutter driving unit 530.

The control unit 520 analyzes a period of the sync signal, and transmits a sleep mode signal enabling the sync signal receiving unit 510 to be set in a sleep mode and a wake-up mode signal enabling the sync signal receiving unit 510 to be set in a wake-up state to the sync signal receiving unit 510 according to the period of the sync signal.

For example, the control unit 520 analyze's the period of the sync signal, and transmits the wake-up mode signal and the sleep mode signal to the sync signal receiving unit 510 to set the sync signal receiving unit 510 in a sync signal receivable state for a duration in which the sync signal is received and to set the sync signal receiving unit 510 in an off state for a duration in which the sync signal is not received.

Accordingly, as shown in FIG. 3, the sync signal receiving unit 510 receives the wake-up mode signal before receiving the sync signal so that the sync signal receiving unit 510 is set in a reception waiting state, that is, the on state, and receives the sleep mode signal after receiving the sync signal so that the sync signal receiving unit 510 is set in the off state until a following sync signal is received. That is, since the control unit 520 controls the sync signal receiving unit 510 to be set in the reception waiting state only for a predetermined period of time and then to be set in the off state for a remaining period of time, current consumption of the 3D glasses may be minimized.

In other words, the control unit 520 analyzes the period of the sync signal, and generates a mode signal according to a minimum period, and the sync signal receiving unit 510, according to the mode signal, performs a reception operation only for a predetermined period of time necessary to receive the sync signal.

The shutter driving unit 530 drives the left and right shutters according to a shutter control signal received from the control unit 520 so that the left and right shutters of the 3D glasses may be operated to correspond to a left eye image and a right eye image of the 3D display device.

In FIG. 5, since the sync signal receiving unit 510 and the control unit 520 of the 3D glasses both transmit to and receive information from each other, the sync signal receiving unit 510 may receive a mode signal from the control unit 520 to set the sync signal receiving unit 510 in the sync signal receivable state for a predetermined period of time, that is, a period of time necessary to receive the sync signal, and may receive different mode signal to be set in the off state for a remaining period of time, thereby minimising current consumption of the apparatus for controlling the shutters of the 3D glasses and increasing the life of a Wifely used in the 3D glasses.

Often, an IR communication method is used. However, for a user wearing 3D glasses in a theatre or the like, there are limitations in receiving 3D images signals. Accordingly, a radio frequency (RF) communication method may be used. In general, however, RF communication has a problem in that current consumed by 3D glasses using an RF communication method is about 45 mA, which is much higher than current consumed by 3D glasses using an IR communication method, which may be about 1.4 mA. The apparatus for controlling the left and right shutters of the 3D glasses of FIG. 5 may be a solution to this problem.

For example, the amount of current consumed when the apparatus for controlling the left and right shutters of the 3D glasses of FIG. 5 is applied to the 3D glasses using an RF communication method, which consume an average current of 45 mA, is calculated as follows.

When the sync signal receiving unit 510 is controlled to have a sync frequency of 7.5 Hz, a period of 133.3 msec, and an operating time of 2 msec, the amount of consumed current is 0.67 mA.

$$45 mA \times \frac{2 m sec}{133.6 m sec} = 0.67 mA$$

That is, even if an RF communication method is used, an average current consumption may be less than 1.45 mA, which is an average current consumption of IR communication method.

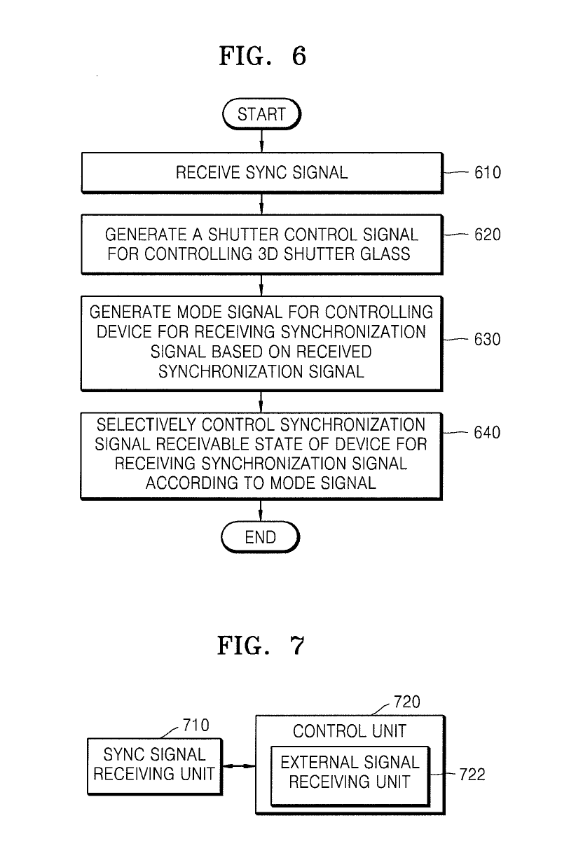

FIG. 6 is a flowchart illustrating a method of controlling left and right shutters using the apparatus for controlling the left and right shutters of the 3D glasses of FIG. 5, according to an exemplary embodiment.

In operation 610, a sync signal is received from, for example, a transmitter of a 3D display device.

In operation 620, a shutter control signal for controlling the left and right shutters of the 3D glasses according to the sync signal is generated.

In operation 630, a period of the sync signal is checked, and a sleep mode signal enabling an apparatus for receiving a sync signal to be set in the sleep state and a wake-up mode signal enabling the apparatus for receiving the sync signal to be set in the wake-up state are generated according to the period of the sync signal, and transmitted to the apparatus for receiving the sync signal.

In operation 640, the apparatus for receiving the sync signal is selectively set in the sync signal receivable state according to the wake-up mode signal. For example, the apparatus for receiving the sync signal is set in the reception waiting state according to the wake-up mode signal or is set in the off state according to the sleep mode signal.

FIG. 7 is a block diagram of an apparatus for receiving a sync signal, according to another exemplary embodiment.

Since a sync signal receiving unit 710 of FIG. 7 performs the same function as the sync signal receiving unit 210 of FIG. 2, a detailed explanation thereof will not be given.

In FIG. 7, the control unit 720 further includes an external signal receiving unit 722. A signal received by the external signal receiving unit 722 may be a specific signal transmitted using wireless communication such as IR, Bluetooth, WLAN, or Zigbee. If the external signal receiving unit 722 receives a specific signal, a control unit 720 initiates a mode signal for setting the sync signal receiving unit 710 in an on state only for a period of time necessary to receive the sync signal and setting in an off state for a remaining period of time, and generates a new mode signal.

Accordingly, even if the apparatus for receiving the sync signal misses synchronization, or malfunctions, user inconvenience may be minimized and the apparatus for receiving the sync signal may be synchronized with a transmitter for transmitting the sync signal.

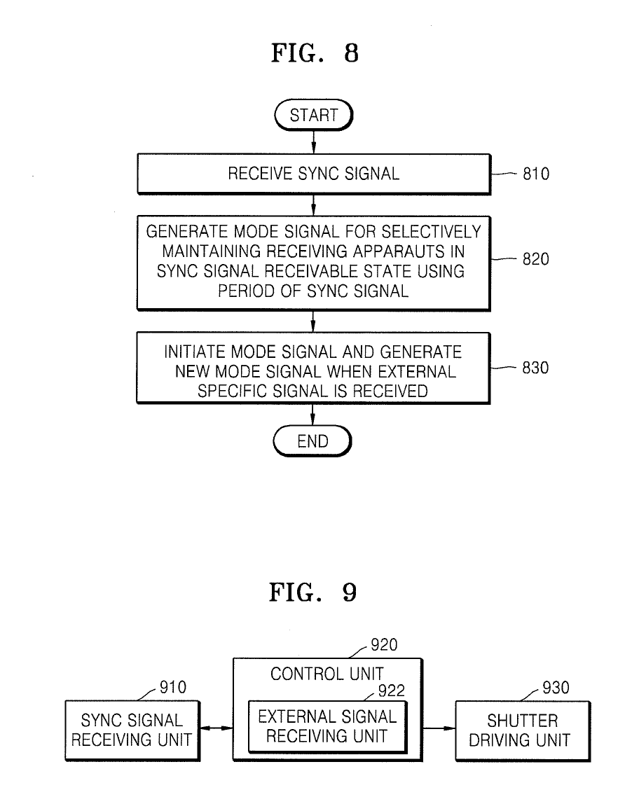

FIG. 8 is a flowchart illustrating a method of receiving a sync signal in the apparatus for receiving the sync signal of FIG. 7, according to another exemplary embodiment.

In operation 810, a sync signal is received from, for example, a transmitter of a 3D display device.

In operation 820, a period of the sync signal is analyzed, and a mode signal for selectively setting the apparatus for receiving the sync signal in a sync signal receivable state according to the period of the sync signal is generated.

In operation 830, when an external specific signal is received, the mode signal is initialized and a new mode signal is generated.

FIG. 9 is a block diagram of an apparatus for controlling left and right shutters of 3D glasses, according to another exemplary embodiment.

Since a sync signal receiving unit 910 and a shutter driving unit 930 of FIG. 9 perform the same functions as the sync signal receiving unit 510 and the shutter driving unit 530 of FIG. 5, a detailed explanation thereof will not be given.

The control unit 920 further includes an external signal receiving unit 922. A signal received by the external signal receiving unit 922 may be a specific signal transmitted using wireless communication such as IR, Bluetooth, WLAN, or Zigbee. If the external signal receiving unit 922 receives a specific signal, the control unit 920 initializes a shutter control unit and a mode signal, and generates a new shutter control signal and a new mode signal.

Accordingly, even if a shutter driving tuning of the 3D glasses is missed because a user staring at a certain place suddenly turns his/her head to see a 3D display device, or even if the 3D glasses malfunctions for some reason, user inconvenience may be minimised and the 3D glasses may be synchronized with the 3D display device.

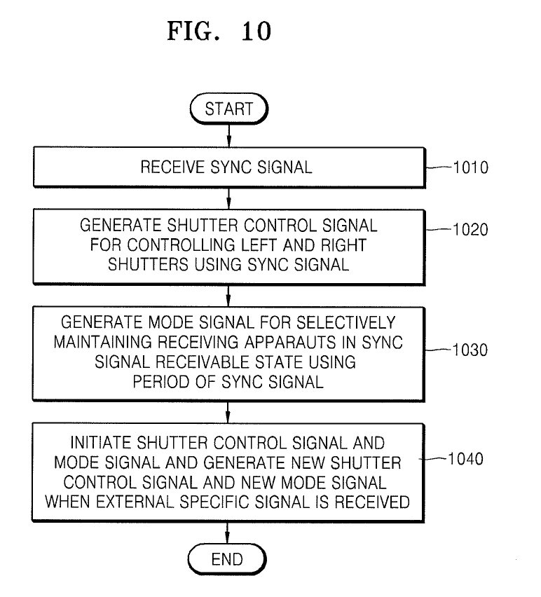

FIG. 10 is a flowchart illustrating a method of controlling left and right shutters in the apparatus for controlling the left and right shutters of the 3D glasses of FIG. 9, according to another exemplary embodiment.

In operation 1010, a sync signal is received from, for example, a transmitter of a 3D display device.

In operation 1020, a shutter control signal for controlling the left and right shutters is generated according to the sync signal, and the left and right shutters are controlled based on the shutter control signal.

In operation 1030, a period of the sync signal is analyzed, and a mode signal for selectively setting an apparatus for receiving a sync signal in a sync signal receivable state according to the period of the sync signal is generated.

In operation 1040, when an external specific signal is received, the shutter control signal and the mode signal are initialized, and a new shutter control signal and a new mode signal are generated.

Although example embodiments have been described, those skilled in the art will readily appreciate that many modifications to the example embodiments are possible without materially departing from the novel teachings and advantages of example embodiments. Therefore, it is to be understood that the foregoing is illustrative of example embodiments and is not to be construed as limited to thereto, and that modifications to the disclosed embodiments, as well as other embodiments, are intended to be included within the scope of the appended claims. Example embodiments are defined by the following claims, with equivalents of the claims to be included therein. The exemplary embodiments may be embodied as computer-readable codes on a computer-readable recording medium.

The computer readable recording medium is any data storage device that may store data which may be thereafter read by a computer system. Examples of the computer readable recording medium include read-only memory (ROM), random-access memory (RAM), CD-ROMs, magnetic tapes, floppy disks, optical data storage devices, etc. The computer readable recording medium may also be distributed over network coupled computer systems so that the computer readable code is stored and executed in a distributed fashion.

What is claimed is:

1. A synchronization signal receiver device comprising:
a receiver which receives a synchronization signal from a source unit; and
a controller which analyzes a period of the received synchronization signal and generates a mode signal according to the analyzed period of the received synchronization to control the receiver,
wherein the receiver is selectively operable to receive the synchronization signal according to the mode signal.

2. The device of claim 1, wherein the receiver which receives the mode signal from controller receives the synchronization signal during a predetermined period.

3. The device of claim 1, wherein the controller generates a first mode signal which sets the receiver receiving status to be ON to receive the synchronization signal and a second mode signal which sets the synchronization signal receiver receiving status to be OFF, wherein the first mode signal is transferred before the receiver receives the synchronization signal and the second mode signal is transferred after the receiver receives the synchronization signal.

4. The device of claim 2, wherein the receiver operates in the receiving status ON and the receiving status OFF for each period of the synchronization signal

5. The device of claim 2, wherein the controller generates the mode signal for each period of the synchronization signal and transfers the mode signal to the receiver.

6. The device of claim 1, wherein the controller comprises an external signal receiver, wherein if the external signal receiver receives a predetermined signal, the controller initializes the mode signal and then regenerates the mode signal.

7. A method of receiving a synchronization signal, the method comprising:
receiving a synchronization signal from a source unit;
analyzing a period of the received synchronization signal;
generating a mode signal according to the analyzed period of the received synchronization to control a device for receiving the synchronization signal, and
selectively controlling a synchronization signal receivable state of the device for receiving the synchronization signal according to the mode signal.

8. The method of claim 7, wherein the selectively controlling of the synchronization signal receivable state of the device comprises setting the device in the synchronization signal receivable state during a predetermined period.

9. Three-dimensional (3D) shutter glasses comprising:
a receiver which receives a synchronization signal from a source unit;
a controller which generates a shutter control signal to control 3D shutter glasses and a mode signal to control the receiver based on the received synchronization signal; and
a shutter operation unit operates selectively a left shutter or a right shutter according to the generated shutter control signal,
wherein the receiver is selectively operable to receive the synchronization signal according to the mode signal.

10. The 3D shutter glasses of claim 9, wherein the receiver which receives the mode signal from the controller is operable to receive the synchronization signal during a predetermined period.

11. The 3D shutter glasses
of claim 9, wherein the controller generates a first mode signal which sets the receiving status of the receiver to be ON to receive the synchronization signal and a second mode signal which sets the receiving status of the receiver to be OFF, wherein the first mode signal is transferred before the receiver receives the synchronization signal and the second mode signal is transferred after the receiver receives the synchronization signal.

12. The 3D shutter glasses of claim 10, wherein the receiver operates in the receiving status ON and the receiving status OFF for each period of the synchronization signal

13. The 3D shutter glass of claim 10, wherein the controller generates the mode signal for each period of the synchronization signal and transfers the mode signal to synchronization signal receiver.

14. The 3D shutter glasses of claim 10, wherein the controller analyzes a period of the synchronization signal, and generates a control signal according to a minimum period

15. The 3D shutter glasses of claim 9, wherein the controller comprises an external signal receiver, wherein if the external signal receiver receives a predetermined signal, the controller initializes the mode signal then regenerates the mode signal.

16. A method of controlling 3D shutter glasses, the method comprising:
receiving a synchronization signal from a source unit;
generating a shutter control signal for controlling 3D shutter glasses and a mode signal for controlling a device for receiving a synchronization signal based on the received synchronization signal;
selectively operating a left shutter or a right shutter according to the generated shutter control signal, and
selectively controlling a synchronization signal receivable state of the device for receiving the synchronization signal according to the mode signal.

17. The method of claim 16, wherein the selectively controlling of the synchronization signal receivable state of the device comprises setting the device in a synchronization signal receivable state during a predetermined period.

18. The method of claim 16, further comprising generating a first mode signal which sets the device receiving status to be ON to receive the synchronization signal and a second mode signal which sets the device receiving status to be OFF, wherein the first mode signal is transferred before the device receives the synchronization signal and the second mode signal is transferred after the device receives the synchronization signal.

19. A computer-readable recording medium having embodied thereon a program for executing a method of receiving a sync signal, wherein the method comprises:
receiving a synchronization signal from a source unit;
analyzing a period of the received synchronization signal;
generating a mode signal according to the analyzed period of the received synchronization to control a device for receiving the synchronization signal, and
selectively controlling a synchronization signal receivable state of the device for receiving the synchronization signal according to the mode signal.

20. A computer-readable recording medium having embodied thereon a program for executing a method of controlling 3D shutter glasses, wherein the method comprises:
receiving a synchronization signal from a source unit;
generating a shutter control signal for controlling 3D shutter glasses and a mode signal for controlling a device for receiving a synchronization signal based on the received synchronization signal;
selectively operating a left shutter or a right shutter according to the generated shutter control signal, and
selectively controlling a synchronization signal receivable state of the device for receiving the synchronization signal according to the mode signal.

21. A method of controlling 3D glasses including a left shutter and a right shutter, the method comprising:
receiving a sync signal from a source unit;
generating a shutter control signal for controlling a left shutter and a right shutter of the 3D glasses and a mode signal for controlling the receiving of the sync signal based on the received sync signal;
selectively operating the left shutter or the right shutter according to the generated shutter control signal, and
selectively controlling the receiving the sync signal by setting a receiving state to be ON when receiving a pulse of the sync signal and the receiving state to be OFF when not receiving the pulse of the sync signal.

22. The method of claim 21, wherein the receiving state in OFF is a sleep mode.
